(19) United States
(12) Patent Application Publication
(10) Pub. No.: US 2022/0225593 A1
(43) Pub. Date: Jul. 21, 2022

(54) APPARATUS FOR FEEDING A PET COMPRISING MAT WITH RECEPTACLES MOUNTED THEREON

(71) Applicant: MOOSE PRINT INC., Edmonton (CA)

(72) Inventor: DARCY ROY MOOSE, WINNIPEG (CA)

(21) Appl. No.: 17/577,174

(22) Filed: Jan. 17, 2022

Related U.S. Application Data
(60) Provisional application No. 63/138,637, filed on Jan. 18, 2021.

(51) Int. Cl. A01K 5/01

(52) U.S. Cl. CPC A01K 5/0135

(57) ABSTRACT

An apparatus for feeding a pet comprises a generally planar mat with an elliptical-shaped peripheral edge, and first and second receptacles mounted in fixed relation to the mat. The receptacles are disposed in spaced relation to the peripheral edge of the mat and a mat area delimited thereby is sized such that during feeding from at least one of the receptacles the pet stands on a top side of the mat so as to anchor the mat in substantially fixed location on the support surface.

This application claims the benefit under 35 U.S.C. 119(e) of U.S. Provisional application Ser. No. 63/138,637 filed Jan. 18, 2021.

### FIELD OF THE INVENTION

The present invention relates to an apparatus for feeding a pet, and more specifically to such an apparatus comprising at least one receptacle and an underlying mat to which the at least one receptacle is fixedly attached and which is sized sufficiently large such that during feeding the pet stands on the mat so as to anchor the apparatus in fixed location to a support surface thereunder.

### BACKGROUND

Pets are messy eaters and thus it is desirable to provide an underlying mat beneath receptacles containing food or water to be consumed by the pet. It is also desirable that the receptacles are attached to the mat in fixed relation thereto so that there is no relative movement as a pet consumes its food or water by lapping thereof with the tongue, which often causes the respective receptacle from which the food or water is being removed to shift. Any shifting of the interconnected receptacles and mat can be prevented by suitable anchoring of the mat to an underlying support surface.

### SUMMARY OF THE INVENTION

According to an aspect of the invention there is provided an apparatus for feeding a pet comprising:

a generally planar mat having a top side arranged to receive the pet standing thereon, an underside arranged for gripping engagement with a support surface, and a peripheral edge delimiting the top side and the underside;

first and second receptacles having bottoms surrounded by upstanding peripheral walls which collectively define cavities arranged for containing food or water to be consumed by the pet, the first and second receptacles being mounted in fixed relation to the mat such that the peripheral walls of the receptacles stand upwardly from the top side thereof;

the peripheral edge of the mat being elliptical-shaped;

the first and second receptacles being disposed in spaced relation to the peripheral edge of the mat and a mat area delimited thereby being sized such that during feeding from at least one of the first and second receptacles the pet stands on the top side of the mat so as to anchor the mat in substantially fixed location on the support surface.

This arrangement provides a suitable surface area of the mat conducive to locating or positioning the pet in standing relation on the mat when it is consuming contents of the receptacles, such that the weight of the pet standing on the met acts to anchor the mat relative to the support surface thereunder.

The curved peripheral edge allows freedom in rotational orientation of the mat on the support surface particularly in proximity to an interior corner formed between two upstanding wall surfaces.

Preferably, the mat area is sized about three to about six times larger than areas delimited by the peripheral walls of the first and second receptacles.

In one arrangement, the mat area is about three times larger than the areas of the receptacles.

In another arrangement, the mat area is about four times larger than the areas of the receptacles.

In yet another arrangement, the mat area is about five times larger than the areas of the receptacles.

In a further arrangement, the mat area is about six times larger than the areas of the receptacles.

In yet a further arrangement, the sizing of the mat area relative to the area of the receptacles is a range formed by any combination of the foregoing relative sizings.

In one arrangement, the peripheral walls of the first and second receptacles are spaced at least about 12 inches from the peripheral edge of the mat.

Preferably, the first and second receptacles each are spaced from a center of the mat, but a pair of the receptacles is centered relative thereto.

Preferably, the first and second receptacles are disposed closer to one another than they are spaced from the peripheral edge of the mat.

In one arrangement, the peripheral walls of the first and second receptacles are elliptical in shape, and the first and second receptacles are mounted to the elliptical-shaped mat in angularly offset rotation relative thereto.

In one such arrangement, the first and second receptacles are angularly offset relative to the mat by a common angle but in opposite directions such that the receptacles are located on either side of a common central area on the mat from which the pet can consume the food or water in either one of the receptacles.

Preferably, the first and second receptacles are integral with the mat, and the receptacles and the mat are made of a common flexible hydrophilic material.

Preferably, the bottoms of the receptacles are distinct from the mat but substantially coplanar therewith such that undersides of the bottoms of the receptacles are also arranged for grippingly engaging the support surface.

### BRIEF DESCRIPTION OF THE DRAWINGS

The invention will now be described in conjunction with the accompanying drawings in which:

FIG. 1 is a top perspective view of an arrangement of apparatus for feeding a pet according to the present invention;

FIG. 2 is a bottom perspective view of the arrangement of FIG. 1;

FIG. 3 is an end view of the arrangement of FIG. 1;

FIG. 4 is a side view of the arrangement of FIG. 1;

FIG. 5 is cross-sectional view along line 5-5 in FIG. 4;

FIG. 6 is a bottom plan view of the arrangement of FIG. 1; and

FIG. 7 is a top plan view of the arrangement of FIG. 1.

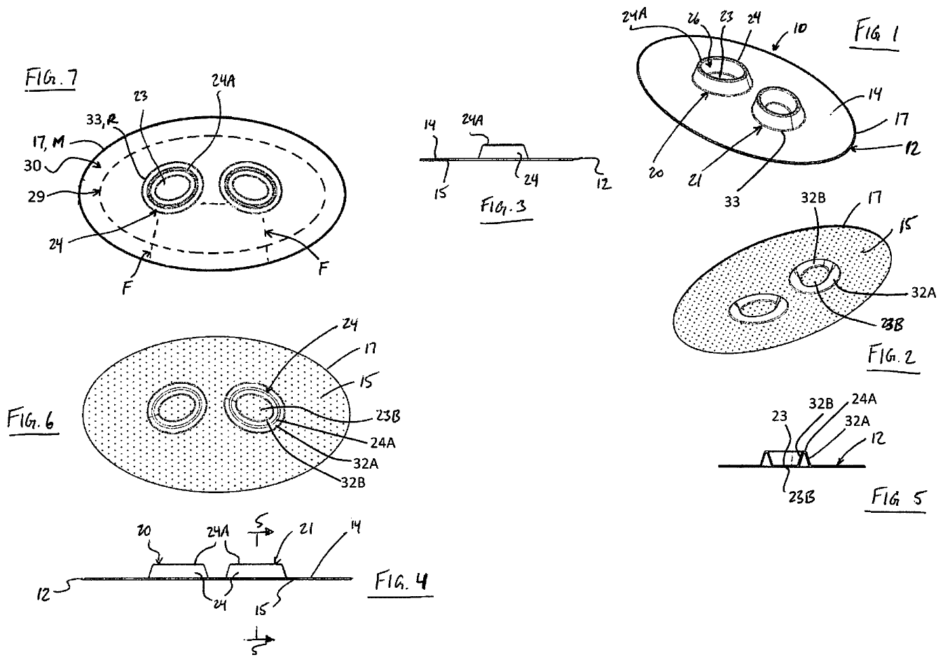

In the drawings like characters of reference indicate corresponding parts in the different figures.

### DETAILED DESCRIPTION

The accompanying figures show an apparatus indicated at 10 for feeding a pet.

The apparatus 10 generally comprises a generally planar mat 12 having a top side 14 arranged to receive the pet standing thereon, an underside 15 arranged for gripping engagement with a support surface, and a peripheral edge 17 delimiting the top side 14 and the underside 15. The mat 12 is made of a flexible hydrophilic material such as silicone rubber. The mat 12 acts as a covering for protecting the support surface against spills of food or water to be consumed by the pet.

In order to contain the food or water for subsequent consumption by the pet, the apparatus 10 includes a pair of receptacles, such as first and second receptacles 20 and 21. Each receptacle 20 or 21 has a bottom 23 which is surrounded by an upstanding peripheral wall 24, so as to collectively define a cavity 26 arranged for containing the consumable pet food product therein. The receptacles 20 and 21 are located on the mat 12 such that the mat acts as a base for supporting the receptacles as well as a container to contain spillage from the receptacles to reduce likelihood the same makes contact with the support surface beneath the mat.

In the illustrated arrangement, the peripheral walls 24 of the receptacles are about 2.250 inches tall measured from the underside 15 of the mat to rims 24A which delimit respective top openings of the receptacles.

The mat 12 acts as a container for containing spills from the receptacles by comprising a central depression 29 (shown in stippled line) locating the receptacles and surrounded by a raised peripheral edge portion 30 defining the peripheral edge 17. This is achieved by varying a thickness of the mat measured between the top side 14 and the underside 15. For example, the thickness of the mat at the central depression 29 is about 0.100 inches and at the edge portion 30 it is about 0.188 inches. The receptacles 20, 21 are mounted to the mat at the central depression 29 so as to be encompassed by same.

As it is common for food product-containing receptacles such as 20 or 21 to be displaced due to lapping of the food by the pet, the receptacles 20, 21 are mounted in fixed relation to the mat 12 such that the peripheral walls 24 of the receptacles stand upwardly from the top side 14 of the mat.

The peripheral edge 17 of the mat is elliptical-shaped. Furthermore, the first and second receptacles 20, 21 are disposed in spaced relation to the peripheral edge 17 of the mat, and a mat area M delimited thereby is sized such that during feeding from at least one of the receptacles 20 or 21 the pet stands on the top side 14 of the mat so as to anchor the mat in substantially fixed location on the support surface. In other words, the mat 12 is sized sufficiently large such that the pet is conduced to stand on same while feeding or drinking from one of the receptacles, thereby acting to anchor the receptacles during feeding/drinking.

For optimal performance, the mat area M is sized about three to about six times larger than areas R delimited by the peripheral walls 24 of the receptacles 20, 21. Since the receptacles are sized based on the pet, the foregoing relationship of mat to receptacles encompasses the relationship of distance of front paws to head for cats and dogs for which the mat of the present invention is particularly but not exclusively suited.

In the illustrated arrangement, the elliptical mat has a diameter along a major axis thereof of about 42 inches and a minor diameter, that is a diameter along a minor axis perpendicular to the major axis, of about 24 inches, meaning that the mat area M is about 790 square inches.

To ensure the apparatus 10 functions satisfactorily to anchor the receptacles in fixed relation to the support surface substantially independent of a positioning of the pet relative to the receptacles, the peripheral walls 24 of the first and second receptacles 20, 21 are spaced at least about 12 inches from the mat peripheral edge 17. Furthermore, the receptacles 20, 21 are disposed closer to one another than they are spaced from the peripheral edge 17. This acts to leave a sufficient area of the mat surrounding the receptacles on which the pet can stand.

In further regard to ensuring the apparatus 10 functions satisfactorily to anchor the receptacles in fixed relation to the support surface substantially independent of a positioning of the pet relative to the receptacles, each of the receptacles 20, 21 are spaced from a center of the mat 12, but a pair of the receptacles is centered relative to the mat. In other words, neither one of the receptacles is located at a center of the elliptical mat, but the grouping formed by the receptacles is located at a center. When the receptacles 20, 21 are of a common size and shape, as in the illustrated arrangement, the receptacles 20, 21 are therefore located equidistant from the center of the mat 12.

Since the mat is elliptical in shape, the peripheral walls of the first and second receptacles 20, 21 are also elliptical in shape in the illustrated arrangement of apparatus, such that the receptacles and mat are of a common shape. The receptacles 20, 21 are mounted to the mat in angular offset rotation relative thereto, meaning that major axes of the receptacles are antiparallel to the major axis of the elliptical mat.

More specifically, the first and second receptacles 20, 21 are angularly offset relative to the mat by a common angle but in opposite directions such that the receptacles are located on either side of a common central area F on the mat (shown in using stippled line) from which the pet can consume the food or water in either one of the receptacles. Orienting the two receptacles in this cooperative manner may conduce the pet to stand further from the mat's edge 17 which may enhance anchoring action effected by standing on the mat.

Since the individual receptacles are angular offset relative to the mat, centers thereof are offset or spaced from the major axis of the mat 12. In other words, centers of the receptacles are located on one side of the major axis.

In the illustrated arrangement, the outer diameters of each elliptical receptacle are about 9 inches along the major axis and about 6.6125 inches along the minor axis. The inner diameters measured at the rim 24A is 7.25 inches along the major axis and 5 inches along the minor axis.

To enhance anchoring action effected by standing on the mat, the bottoms 23 of the receptacles are distinct from the mat 12 but substantially coplanar therewith such that undersides 23B of the bottoms of the receptacles are also arranged for grippingly engaging the support surface. This is more clearly shown in FIG. 6 where the receptacles bottoms 23 and their undersides 23B are separated from the mat's underside 15 by respective gaps formed by the peripheral walls 24 of the receptacles. In the illustrated arrangement, both the underside 15 of the mat 12 and the undersides 23B of the receptacles are textured so as to have a rough or uneven surface to enhance gripping and frictionally resist movement across the support surface on which the apparatus is rested.

In the illustrated arrangement, the receptacles 20, 21 are integral with the mat 12 such that the receptacles are made of a common flexible hydrophilic material as the mat 12. This also allows the whole of the apparatus 10 to be folded over on itself for compacting into a folded or rolled storage position, particularly suited for traveling or camping.

As such, the integral peripheral walls 24 each comprise an outer inclined portion 32A extending upwardly from the mat 12 and defining at its bottom a peripheral edge 33 of the respective receptacle. In the illustrated arrangement, the outer wall portion 32A is inclined at an angle of about 108 degrees relative to the mat 12. The outer wall portion 32A meets the rim 24A of the wall disposed in spaced relation above the mat 12. On an inner side of the rim 24A, the respective peripheral wall 24 comprises an inclined inner wall portion 32B which extends downwardly and inwardly towards a center of the receptacle. At a bottom of the inner wall portion 32B is the bottom 23 of the receptacle. Thus, in the illustrated arrangement, the inner diameters of each receptacle at the bottom thereof are about 5.5 inches along the major axis and 3.3875 inches along the minor axis.

This arrangement provides a suitable surface area of the mat conducive to locating or positioning the pet in standing relation on the mat when it is consuming contents of the receptacles, such that the weight of the pet standing on the met acts to anchor the mat relative to the support surface thereunder.

The curved peripheral edge allows freedom in rotational orientation of the mat on the support surface particularly in proximity to an interior corner formed between two upstanding wall surfaces.

In use, the apparatus 10 is rested on a support surface such as a floor with the underside 15 in contact therewith. Undersides 23B of the receptacles also gripping engage the underlying support surface. Food and/or water are transferred to the receptacles 20, 21. With food and/or water carried in the receptacles 20, 21, the pet is conduced to stand on the mat to retrieve the food and/or water from the receptacles, due to the size and shape of the mat and arrangement of receptacles thereon, which acts to anchor the mat in fixed location on the support surface during feeding from the receptacles.

The scope of the claims should not be limited by the preferred embodiments set forth in the examples but should be given the broadest interpretation consistent with the specification as a whole.

1. An apparatus for feeding a pet comprising:
a generally planar mat having a top side arranged to receive the pet standing thereon, an underside arranged for gripping engagement with a support surface, and a peripheral edge delimiting the top side and the underside;
first and second receptacles having bottoms surrounded by upstanding peripheral walls which collectively define cavities arranged for containing food or water to be consumed by the pet, the first and second receptacles being mounted in fixed relation to the mat such that the peripheral walls of the receptacles stand upwardly from the top side thereof;
the peripheral edge of the mat being elliptical-shaped;
the first and second receptacles being disposed in spaced relation to the peripheral edge of the mat and a mat area delimited thereby being sized such that during feeding from at least one of the first and second receptacles the pet stands on the top side of the mat so as to anchor the mat in substantially fixed location on the support surface.

2. The apparatus of claim 1 wherein the mat area is sized about three to about six times larger than areas delimited by the peripheral walls of the first and second receptacles.

3. The apparatus of claim 1 wherein the peripheral walls of the first and second receptacles are spaced at least about 12 inches from the peripheral edge of the mat.

4. The apparatus of claim 1 wherein the first and second receptacles each are spaced from a center of the mat, but a pair of the receptacles is centered relative thereto.

5. The apparatus of claim 1 wherein the first and second receptacles are disposed closer to one another than they are spaced from the peripheral edge of the mat.

6. The apparatus of claim 1 wherein the peripheral walls of the first and second receptacles are elliptical in shape, and the first and second receptacles are mounted to the elliptical-shaped mat in angularly offset rotation relative thereto.

7. The apparatus of claim 6 wherein the first and second receptacles are angularly offset relative to the mat by a common angle but in opposite directions such that the receptacles are located on either side of a common central area on the mat from which the pet can consume the food or water in either one of the receptacles.

8. The apparatus of claim 1 wherein the first and second receptacles are integral with the mat, and the receptacles and the mat are made of a common flexible hydrophilic material.

9. The apparatus of claim 1 wherein the bottoms of the receptacles are distinct from the mat but substantially coplanar therewith such that undersides of the bottoms of the receptacles are also arranged for grippingly engaging the support surface.
